(19) United States
(12) Patent Application Publication
(10) Pub. No.: US 2022/0018078 A1
(43) Pub. Date: Jan. 20, 2022

(54) Composite System and Method for Pile Construction and Repair

(71) Applicants: Zbigniew Andrew Szczepaniak, New Britain, CT (US); Douglas A. Cheney, Waterbury, CT (US); Bernard L. Baldwin, JR., Stratford, CT (US); Michael K. Harvey, Madison, CT (US)

(72) Inventors: Zbigniew Andrew Szczepaniak, New Britain, CT (US); Douglas A. Cheney, Waterbury, CT (US); Bernard L. Baldwin, JR., Stratford, CT (US); Michael K. Harvey, Madison, CT (US)

(21) Appl. No.: 17/365,403

(22) Filed: Jul. 1, 2021

Related U.S. Application Data
(60) Provisional application No. 63/053,015, filed on Jul. 17, 2020.

(51) Int. Cl. E02B 17/00; E02D 5/64; E02B 3/16; E02D 5/60; C04B 26/14; C04B 24/02; C04B 24/32; C04B 24/12; C04B 18/08; C04B 14/06; C04B 40/06

(52) U.S. Cl. CPC E02B 17/0034; E02B 17/0017; E02D 5/64; E02B 3/16; E02D 5/60; C04B 26/14; C04B 2103/14; C04B 24/32; C04B 24/122; C04B 18/08; C04B 14/06; C04B 40/065; E02D 2300/0006; C04B 24/02

(57) ABSTRACT

An epoxy grout composition for marine repairs contains: a liquid epoxy resin comprising up to 15 wt. % benzyl alcohol and having a viscosity of 220 to 1100 cps; a liquid hardener comprising up to 25% benzyl alcohol and having a viscosity of 50 to 85 cps and, wherein the total benzyl alcohol content of the combined resin and hardener ranges from 1 to 12 wt. %; and preferably, a particulate inorganic filler comprising 10 to 50 wt. % of particles under 150 μm and 50 to 90 wt. % of particles between 150 μm and 1.18 mm. The composition is particularly suitable for placement in the annular space between a marine structure and a fiberglass composite jacket. The composition may be provided in kit form, with premeasured containers of resin, hardener, and filler. A related method is also disclosed.

### CROSS-REFERENCE TO RELATED APPLICATION

This application claims the benefit of Provisional Patent Application No. 63/053,015 filed on Jul. 17, 2020 by the present inventors, the entire disclosure of which is incorporated herein by reference.

### BACKGROUND OF THE INVENTION

### Field of the Invention

The invention pertains to the field of epoxies and composites for pile construction or repair, particularly those in marine or aquatic environments, using jacketed formwork.

### Description of Related Art

Many marine structures such as piles, are subject to damaging conditions over their lifetime, including mechanical damage and wear associated with wave action, impacts with ice, general freeze/thaw deterioration, corrosion in the case of metal structures, and damage from shipworms (marine borers) and other wildlife. Methods have been developed to repair and restore such structures, and/or protect them against further damage, and the most common method is to form a split cylindrical jacket of fiberglass or other composite material, place the jacket around the pile, and fill the resulting annular gap with a slurry or grout that will harden into a solid, durable structure surrounding the original pile. Because this work must be performed in situ, significant engineering challenges arise.

In situ construction and repairs often use an epoxy-based composite system, and typically require the epoxy to be blended and then pumped some considerable distance to the individual piles, particularly in underwater and marine environments where the pumping must proceed through the water and to the pile. It is desirable that the repair material can be pumped over long distances because this will reduce the time and cost to reposition equipment and/or place equipment in areas to minimize the risk of environmental damage or spills. Current technologies typically rely on entrained air in the system and/or the use of surfactants to aid in pumpability.

The most commonly used surfactant in many pile repair products is nonylphenol. Unfortunately, nonylphenol is very toxic to aquatic/marine life and is now prohibited in Europe. Separately, entraining air for pumpability poses other problems, particularly separation of the product, which leads to honeycombing on the top of the lift, creating weak spots in the repair particularly when multiple lifts are being conducted. A lift is the amount of material pumped into a jacket. Currently, depending on the height of the repaired pile, it may involve a few “lifts”, with the first lift allowed to cure before another lift is placed. This reduces the hydrostatic pressure of the liquid product and thereby protects against blowout of the fiberglass jacket. Each lift generally has its own access port for injecting the grout, and after the first lift is placed, the next lift is injected at a higher access port.

Current epoxy-filled jackets do not have enough bond strength both to the substrate and to the outer fiberglass sleeve to allow in situ, unreinforced repairs of support structures. This is particularly evident in marine, underwater environments where in situ repairs are difficult because bond strength is required, and extensive surface preparation of the original pile is not possible.

What is needed, therefore, is a composite repair system that has improved flow characteristics and pumpability, that avoids the use of toxic surfactants, and has improved bond strength with the original construction and with the surrounding fiberglass jacket.

In the field of polymer concretes and grouts, many formulations have been disclosed in which nonylphenol is used for a variety of purposes, and in some cases benzyl alcohol is also discussed and/or used alone or in combination therewith:

U.S. Pat. Nos. 4,828,879 and 4,904,711 to Sellstrom et al. disclose polymer concrete compositions for road repairs. Nonylphenol was added at 10 to 40 parts by weight per 100 parts epoxy resin.

U.S. Pat. No. 5,258,087 to Symons discloses a corrugated structure of paper or the like, impregnated with thermosetting resin. The resin contains an “extending liquid” or solvent, and a catalyst. The extending liquid may include various halocarbon solvents, benzyl alcohol, nonylphenol, dibutyl phthalate, xylene, and methyl ethyl ketone. The extending liquid is taught to comprise 20 to 100% per weight of resin.

U.S. Pat. No. 5,296,520 to Gerber discloses latent acid curable compositions based on phenolic resins. Reactive diluents include nonylphenol, phenolics, allylic and benzylic alcohols, acetyls, etc., with a preferred reactive diluent being furfuryl alcohol at 5 to 100% per weight of resin.

U.S. Pat. No. 5,567,788 to Zezza discloses a two-part system suitable for coating or impregnating concrete. The resin contains a polyether-ene, a free radical-polymerizable monomer such as an acrylate ester, a free radical initiator, and a promoter. One acrylate ester is taught to be nonylphenol ethoxylate (9) methacrylate.

U.S. Pat. No. 6,328,106 to Griffith et al. discloses compositions for sealing subterranean zones in oil and gas wells. The composition may include water, an aqueous rubber latex, an organophilic clay, sodium carbonate, an epoxy resin, and a hardener. Ethoxylated nonylphenol is taught to be a latex stabilizing surfactant, added at a rate up to about 35% by weight of the aqueous rubber latex.

U.S. Pat. No. 8,980,979 to Dettloff et al. describes a fast-curing composition to affix pavement markers to concrete. Large amounts of alkylated phenols, including nonylphenol, are contemplated, e.g., 10 to 55% by weight of the curable composition.

U.S. Pat. No. 10,357,755 to Bisque et al. discloses a material for solidifying and stabilizing power plant wastes. A leach reduction additive mixture contains an emulsifying agent, which may include nonylphenol.

U.S. Pat. No. 10,988,664 to Al-Yami et al. discloses compositions for sealing lost circulation zones in a wellbore. An epoxy resin may include an accelerator such as alcohols, phenols, aminoalcohols, or amines. Examples include benzyl alcohol and mono-nonylphenol.

U.S. Pat. No. 6,133,403 to Gerber discloses acid hardenable phenolic resin compositions containing reactive diluents including benzylic alcohol, benzylic ether, ethylene glycol, etc.

U.S. Pat. No. 6,790,544 to Schmitz discloses a multilayer structure having a layer of cement concrete and a layer of polymer concrete. The polymer concrete is formed as a 1:1 emulsion of a polyamine epoxy resin adduct and a mixture of bisphenol-A-epichlorohydrin resin, p-tert butyphenyl diglycidyl ether, and benzyl alcohol. No other proportions of the mixture are specifically taught.

U.S. Pat. No. 9,676,898 to Ortelt et al discloses curable epoxy resins that can accommodate reduced, or even zero, quantities of benzyl alcohol in order to reduce total volatile organic compounds (VOCs) in paints and coatings.

### Objects and Advantages

Objects of the present invention include the following: providing an improved resin/hardener system for marine repairs; providing a filled epoxy material having improved flow characteristics and pumpability; providing a marine repair material that is less toxic to marine life; providing a marine repair system in which the filler material exhibits better adhesion to the pile and the pile jacket; and, providing an improved method for repairing and restoring marine structures. These and other objects and advantages of the invention will become apparent from consideration of the following specification, read in conjunction with the drawings.

### SUMMARY OF THE INVENTION

According to one aspect of the invention, a two-part polymer composition for marine repairs comprises:

a liquid epoxy blend comprising up to 15% benzyl alcohol and having a viscosity of 200 to 1100 cps; and,

a liquid hardener comprising up to 25% benzyl alcohol and having a viscosity of 30 to 85 cps.

According to another aspect of the invention, an epoxy grout composition for marine repairs comprises:

a liquid epoxy blend comprising up to 15% benzyl alcohol and having a viscosity of 200 to 1100 cps;

a liquid hardener comprising up to 25% benzyl alcohol and having a viscosity of 30 to 85 cps; and,

a particulate filler comprising 10 to 50% of a first particulate material having a size range under 100 mesh, and 50 to 90% of a second particulate material having a size range greater than 100 mesh.

According to another aspect of the invention, a grout preparation kit for marine repairs comprises:

a first sealed package holding a first premeasured quantity of a liquid epoxy blend comprising up to 15% benzyl alcohol and having a viscosity of 200 to 1100 cps;

a second sealed package holding a second premeasured quantity of a liquid hardener comprising up to 25% benzyl alcohol and having a viscosity of 30 to 85 cps; and,

a package holding a third premeasured quantity of a dry particulate filler comprising 10 to 50% of a first particulate material having a size range under 100 mesh, and 50 to 90% of a second particulate material having a size range greater than 100 mesh, wherein:
the premeasured quantities of the liquid epoxy blend and hardener, when combined, comprise 1 to 12 wt. % benzyl alcohol, and,
the premeasured quantity of dry particulate filler, when combined with the premeasured quantities of epoxy blend and hardener, produces a flowable grout composition suitable for placement into a pile jacket.

According to another aspect of the invention, a method for protecting a marine structure comprises the steps of:

forming a split polymer composite jacket;

placing the composite jacket around a selected marine structure;

drawing the composite jacket together and securing the resulting overlap;

sealing the bottom of the jacket with a curable composition;

forming an epoxy grout composition comprising:
a liquid epoxy resin comprising up to 15% benzyl alcohol and having a viscosity of 200 to 1100 cps.
a liquid hardener comprising up to 25% benzyl alcohol and having a viscosity of 30 to 85 cps, and,
a particulate filler comprising 10 to 50% of a first particulate material having a size range under 100 mesh, and 50 to 90% of a second particulate material having a size range greater than 100 mesh;

blending the epoxy grout composition and placing it into the annular space between the polymer composite jacket and the marine structure; and,

allowing the epoxy grout composition to cure in place.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIGS. 1A-C present a schematic illustration of the general elements of marine repairs using some aspects of the present invention. FIG. 1A shows the entire repair setup; FIG. 1B shows the tongue and groove joint to secure the seam on the jacket; and FIG. 1C shows a cross section of the repair.

FIG. 2 presents a flow diagram illustrating some aspects of the inventive method.

### DETAILED DESCRIPTION OF THE INVENTION

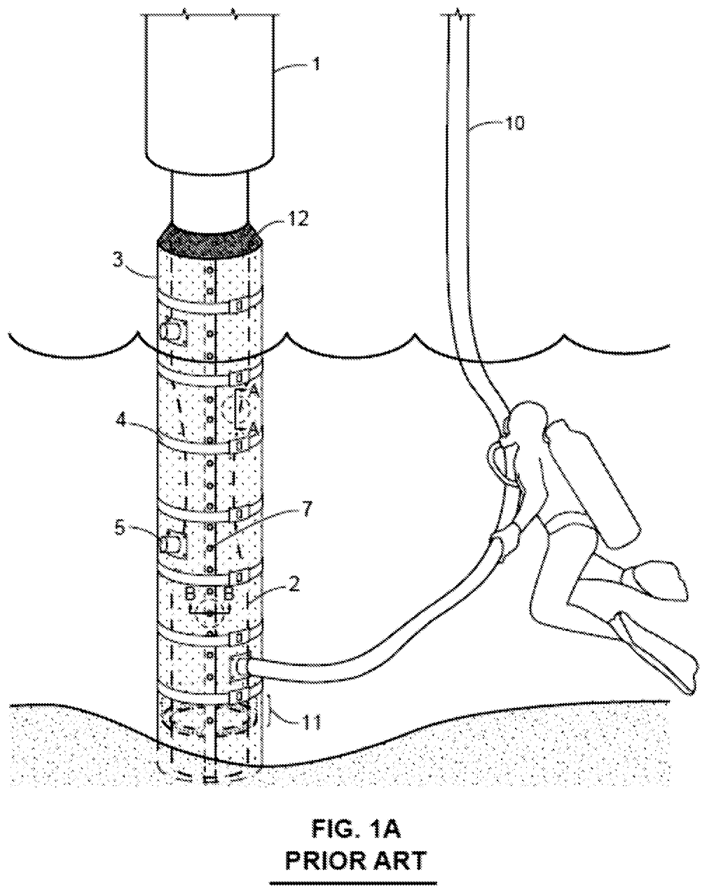

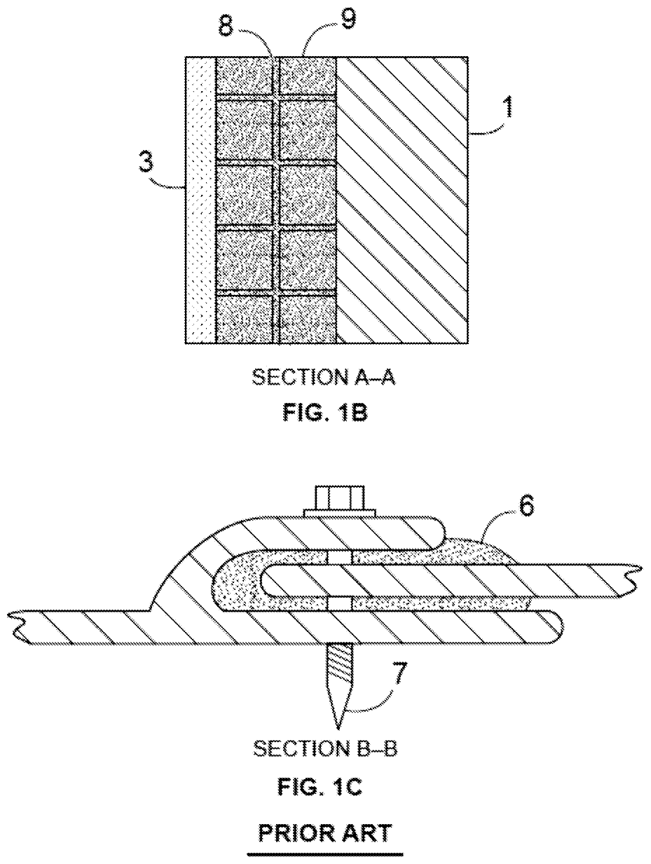

Many marine infrastructure projects involve repairing piles that support piers, bridges, terminals, and wharves, as the piles undergo damage from physical erosion, corrosion, wood-boring animals, etc. A standard method for such repairs is illustrated schematically in FIG. 1. In FIG. 1A, a supporting pile 1 has suffered wear and tear, which reduced its thickness as shown by the dashed lines at 2. The damaged pile is typically given some surface preparation (typically high-pressure water cleaning) to remove corrosion products, marine life, mud, etc. A fiberglass jacket 3, which might typically have a wall thickness of ⅛, ¼, or ½ inch depending on size and specific requirements, is placed around the pile and temporarily secured with nylon ratchet straps 4. A foam backer rod and seal assembly 11 is placed at the bottom of the jacket. Pump ports 5 are typically arranged every five feet, on alternating sides so that fill material can be uniformly injected. As shown schematically in FIG. 1B, jacket 3 typically has a tongue and groove arrangement that is filled with underwater epoxy gel 6 so that as the ratchet straps are tightened, the mating edges of the seam engage securely. Self-tapping stainless steel screws 7 are placed at regular intervals along the seam. FIG. 1C shows the repair in cross section, illustrating the optional placement of a rebar cage 8, which is preferably epoxy-coated for corrosion resistance, in the annular region between the jacket and the pile. The rebar cage 8 may or may not be mechanically anchored to the pile. The annular region is then filled with epoxy or cementitious grout material 9 either by pumping through ports 5, or by pouring in the top if the size and shape of the repair are suitable. After the grout has cured, a splash zone compound 12 (typically a two-part epoxy putty) may be placed on the top to prevent the ingress of water into the repair joint and prevent later freeze-thaw damage.

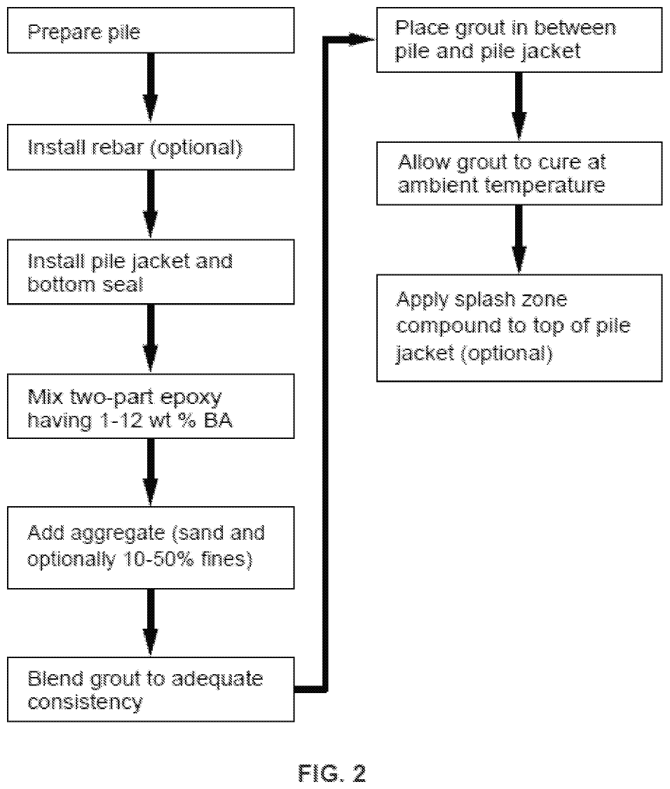

The process steps are illustrated schematically in FIG. 2. Note that in the diagram, “sand” refers generally to any inorganic particulate matter in the size range generally understood to be that of sand as used in the construction industry. It should not be construed to limit the material to quartz or silica sand.

It will be appreciated that this type of installation presents many requirements and challenges with regard to the grout material. It must be sufficiently fluid to pump, often over a considerable distance through pipe 10, and to completely fill the interior spaces if poured in at the top of the annulus. It must have good flexural strength to support the structural loads on the pile. It must have good adhesion strength to all of the components, including the outer surface of the pile, the inner surface of the jacket, and any rebar structures placed in the annular space. It must be relatively benign in the marine environment, and stable for the projected life of the repair (typically 20 to 40 years). It must be homogeneous after placement, with no significant settling of aggregate to the bottom or rising of air bubbles to the top of the column.

The new epoxy system of the present invention combines low viscosity liquids with a combination of flowable aggregate to improve the pumping distances and improve bond strengths. The low viscosity liquids allow for better substrate penetration during in situ repairs, thereby maximizing substrate surface area contact and yielding better adhesion. The low viscosity liquids used in the present invention do not contain nonylphenol.

The epoxy of the present invention is a two-part system, in which the compositions of Part A (resin blend) and Part B (hardener) are summarized in Tables 1 and 2, respectively. Applicants note that benzyl alcohol (BA) may be added to either or both of Part A and Part B, so that the combined amount of benzyl alcohol (in A+B) will not be zero. The total BA content of the combined Parts A and B is preferably 1 to 12 wt. %. The choice of how much BA to add to each part is done to adjust volumetric mixing ratios for ease of use by the customer (e.g., to have a mixing ratio of 2:1 for Part A:Part B). This might, in some cases, lead to a situation where either Part A or Part B might have no BA, but there will never be a situation in which both Parts A and B are free of BA.

TABLE 1
Exemplary composition of Part A

| | Range | Viscosity | |
|---|---|---|---|
| Component | (wt. %) | (cps) | Intended role |
| Epoxy resin blend | 85-100 | 1100 | reactive resin, structural |
| Benzyl alcohol | 0-15 | 2 | viscosity reducer, |
| | | | accelerator |

One suitable epoxy resin is a conventional blend of bisphenol A diglycidyl ether, bisphenol F diglycidyl ether, and ethyl hexyl glycidyl ether (EHGE). Those skilled in the art will appreciate that many suitable epoxy systems are known, including any aromatic epoxy resins, such as: Bisphenol A, F, E and others and/or combinations of those, possibly diluted to reduce viscosity with reactive epoxy diluents like aliphatic mono- or di-glycidyl ethers.

Applicants have discovered that the addition of very low viscosity benzyl alcohol (2 centipoise [cps]) to the resin successfully lowered the viscosity of the epoxy resin from over 700 cps to 410 cps. The addition of benzyl alcohol to the Part A was a result of moving it from Part B to achieve a 2:1 volumetric ratio of A to B respectively. As noted above, this was done in order to create a convenient mixing ratio for the user. The formula stoichiometry contained up to 5% excess of epoxy functionality. The low viscosity system was the main goal to aid the high pumpability without the use of nonylphenol in Part B.

TABLE 2
Exemplary composition of Part B

| | Range | Viscosity | |
|---|---|---|---|
| Component | (wt. %) | (cps) | Intended role |
| Cycloaliphatic amine^{a} | 35-45 | 8 | curing agent, |
| | | | structural |
| Polyoxypropylenediamine | 25-35 | 500 | curing agent, flexibility |
| Benzyl alcohol | 15-25 | 2 | viscosity diluent, |
| | | | accelerator |
| 2,4,6-tris(dimethylaminomethyl)phenol | 1-10 | 185 | catalyst |
| Bis(dimethylaminomethyl)phenol | 0-5 | 185 | catalyst |

^{a}Cyclohexanemethanamine, 5-amino-1,3,3-trimethyl-, or any cycloaliphatic mono- di-, or tri-amine, such as isophoronediamine (IPDA). Alternatively, aliphatic amines such as TEPA, TETA, DETA and similar, low viscosity builds may be suitable for some applications.

As shown in Table 2, Part B contains no nonylphenol, which has important effects on the environmental impact of the inventive compositions, as will be described in later examples. A higher viscosity component, polyoxypropylenediamine, preferably with a molecular weight between 200 and 4000, serves as a plasticizer or flexibilizer. The hydrocarbon chain in this diamine does not have to be linear, but excessive methylation or ethylation of the hydrocarbon would increase stearic hindrance and thus reduce its desired flexibility and/or reactivity. Traditionally, formulations would use higher molecular weights and longer aliphatic chain amines rather than polyoxypropylenediamine to achieve better strength and flexibility. However, there is a trade-off because higher molecular weight amines (e.g. Jeffamine® D-4000, viscosity of 880 cps, Huntsman Performance Coatings) have correspondingly higher viscosities. On the other hand, lower molecular weight aliphatic diamines, with lower viscosity, would lower the flexibility in the system. The invention to some degree mitigates the viscosity penalty and thus potentially allows wider latitude in the choice of plasticizers for particular applications. Polyoxypropylenediamine acts as a “filler” in the inventive curing blend, so Applicants prefer to use a lower viscosity for the other amine component. The IPDA—seen in Table 2 as a component of Part B—is a very low viscosity liquid (8 cps), which compensates the relatively high viscosity of the polyoxypropylenediamine to help keep the viscosity low. With the combination of low viscosity benzyl alcohol, this curing agent blend achieved total viscosity of 35 cps. Benzyl alcohol plays a dual role in the inventive formula. Besides being a diluent, it is a highly active, small-molecule, aromatic alcohol, which accelerates the slow reactivity of cycloaliphatic diamine (IPDA) and polyoxypropylenediamines. Benzyl alcohol is much more reactive than bulky nonylphenol used in conventional formulations. Nonylphenol could also act as an accelerator by itself, but the reactivity of the hydroxyl group of nonylphenol is hindered by the nine-member hydrocarbon chain attached to the phenol because the resulting stearic hindrance minimizes the availability for reaction. If both benzyl alcohol and nonylphenol were used in the curing system, nonylphenol would most likely not react and not play any role besides being a surfactant. Nonylphenol then would have been trapped as a result of steric hindrance in a cured system polymer network and eventually leach outside and pollute the marine environment. The tertiary amines (catalysts) in Table 2 are further aiding the reaction kinetics to achieve desired pot life of the curing system.

As the result of careful formulation of Parts A and B, the mixed viscosity of the liquids (A+B) was 145 cps, which is lower than the formulations of other known products, as seen below in Table 3. One particular formulation includes the epoxy of the present invention, and as can be seen provides the lowest viscosity amongst competing products.

TABLE 3
Viscosities of mixed liquids only (Parts A + B)

| Product | Viscosity @71° F. (cps) |
|---|---|
| This invention^{a} | 145 |
| Prior art^{b} | 155 |
| Prior art^{c} | 390 |
| Prior art^{d} | 420 |

^{a} Five Star Products
^{b}Denso Seashield 550, Denso North America
^{c}Sika Sikadur 35 HI-MOD LPL, Sika USA
^{d}Five Star Products Pile Jacket LPL, Five Star Products

It will be appreciated that with such a low viscosity this new formula will exhibit better bond adhesion to the fiberglass jackets, because of better penetration of surface cracks and porosity for chemical bonding and improved mechanical bonding, in both wet and dry environments. It will be appreciated that there are two types of bonding that occur in this situation: chemical and mechanical. Minimizing the viscosity allows for better surface penetration without the use of the surfactants such as nonylphenol. These bond strength improvements may be further enhanced by unique surface treatment to the rigid fiberglass jacket during manufacturing. That is, a resin with lower viscosity is inherently better able to take advantage of any treatment to roughen the surface texture of the inner surface of the jacket, because it will more effectively penetrate into the surface features thus created. The inner surface of the pile jacket, which will contact the product, could be fairly smooth (as-made condition), or various roughening techniques could be applied, such as sand blasting, spray coating with tiny glass beads or ceramic grit, creating a fabric-like texture by a peel-ply technique, or other methods. Any additional texture will increase the surface area and/or mechanical bonding, and will be inherently more effective as the viscosity of the resin decreases.

In the traditional art it is well known that air entraining can also improve the flow properties of epoxy being pumped for in situ repairs. However, air must remain uniformly distributed across the material. If not, the air will release to the surface causing a foam or honeycomb effect, and if that happens it is deleterious to mechanical and load-bearing properties. Applicant has discovered that by combining the inventive low viscosity liquids with very flowable aggregates as described in some following examples, provides excellent flow characteristics without using air entraining or toxic surfactants such nonylphenol, thereby providing increased stability as well as improved environmental benefits. Other non-toxic flow agents, e.g., lubricating aromatic hydrocarbons, various surfactants such as Aquacer 531 (BYK Chemie), etc., can be used to further aid the flow of the grout.

The flowability of the present invention is achieved not by using a surfactant for air entrainment, but instead by minimizing the viscosity of liquids (such as Parts A and B described above), and further by using a combination of fine particle components in the aggregate. The inventive combination yields an engineered slurry with equal or better flows when compared to the competitive products, and improves the pumpability, without using nonylphenol. Improving the pumping distance is an important benefit, as it minimizes disconnecting or moving equipment and pumps to limit product exposure to the environment. Additionally, reduced viscosity lowers the pumping pressure, thereby enabling many repairs to be filled at a single point of entry (or in a single “lift”).

Regarding the aggregate component (which can be considered Part C of the mixture with Parts A and B referenced above), Applicants have discovered that aggregate particle morphology is important as a factor in the flowability of the system. The blend of coarser material, e.g., sand, used should preferably be round, and furthermore, the addition of controlled amounts of finer particles, e.g., fly ash, can dramatically improve the flowability of the grout, as discussed in the following example. Applicants have found that the very low viscosities of the A and B liquids work synergistically with a properly engineered aggregate to create a great improvement of the flowability of the mixed grout (A+B+C).

Those skilled in the art of construction materials will understand that all of the aggregate materials contemplated herein would be classed as the “fine aggregate” fraction in a concrete mix (the “coarse aggregate” fraction being gravel). In the context of the present invention, the aggregate is divided into two size ranges, a finer size fraction (typically under 100 mesh or <150 μm) and a coarser size fraction (typically −16+100 mesh or 150 μm to 1.18 mm). Many inorganic particulate materials are known in the industry and they include beach sand, mined sand, crushed limestone or other crushed rock, precipitated calcium carbonate, cement kiln dust, Class C fly ash, Class F fly ash, etc.

### Example

A liquid resin mix was made using the Part A and Part B compositions as generally taught in Tables 1 and 2 and it had a mixed viscosity of about 145 cps. To this was added aggregate in the amount of 3000 g of aggregate per 432 g of liquid.
Several batches were made with different proportions of fly ash to sand. The fly ash was a Class C ash and the sand was a blend of −16+40 mesh and −40+70 mesh. After blending the resin and aggregate by conventional means, the slurries were tested using a modified 1″ flow box in accordance with a modified version of ASTM C-1339. “Stability” is a qualitative measure of the degree to which entrained air remains in place, where “none” means that the air rises to the top of the mix and forms a layer of foam, “some” means that some air rises to the top, and “stable” means that no layer of air bubbles was seen on the top surface.

TABLE 4
Flow and stability with various amounts of fly ash

| Fly Ash content in | 1″ Flow | |
|---|---|---|
| the aggregate^{a} | Box (sec)^{b} | Stability |
| 0% | No flow | None |
| 20% | 6 | Some |
| 35% | 6 | Stable |

^{a}Weight %, balance is sand
^{b}ASTM C1339 modified

Further experiments were conducted as summarized in Table 5. Based on all of these results, Applicants prefer to have the aggregate mix contain fly ash or other fine particulate in the range of about 10 to 50 wt. %. However, values outside this range may be suitable for particular applications, and for resin blends having different viscosities. The skilled artisan may therefore optimize the exact mix needed for a particular installation through routine experimentation.

TABLE 5
Flow behavior of different aggregate mixes

| Aggregate Formula (parts/wt.) | | | Mix (parts/wt.) | | | 1″ Flow Box |
|---|---|---|---|---|---|---|
| Sand^{a} −16 + 40 | Fly Ash | Sand^{a} −40 + 70 | Part A | Part B | Part C | Time (sec)^{b} |
| 45 | 35 | 20 | 300 | 132 | 3000 | 26 |
| 45 | 30 | 25 | 300 | 132 | 3000 | 28.5 |
| 50 | 30 | 20 | 300 | 132 | 3000 | 40 |
| 50 | 35 | 15 | 300 | 132 | 3000 | 28 |
| 40 | 40 | 20 | 300 | 132 | 3000 | 40 |
| 40 | 35 | 25 | 300 | 132 | 3000 | 30 |

^{a}US standard mesh designations: 16 = 1.18 mm; 40 = 0.400 mm, 70 = 0.210 mm
^{b}ASTM C-1339

The combination of very low viscosity liquids and the blend of sand-sized particles, preferably below 1 mm, with the right amount of finer particles (e.g., fly ash) provides excellent flow, homogeneity, and stability of the system. Although Applicants prefer that the coarser material has a generally rounded morphology (typical of beach sand, e.g.), it will be appreciated that there is always some natural variation and also that finer sand particles may be somewhat less rounded than coarser particles because the finer fraction includes more fractured particles. Those skilled in the art will be familiar with AASHTO T 304 or similar standard procedures that may be used to quantify the roundness or angularity of sand for particular purposes using parameters such as uncompacted void volume.

With regard to homogeneity, e.g., cross-section analysis for compressive strength (new, present, and competition), the high flexural strength is achieved through balancing various parts of the formula. Applicants have discovered that the abundance of benzyl alcohol accelerates the slow reactivity of cycloaliphatic diamines. This enables the development of high early flexural strength and overall a better polymer chain network, which enhances the overall strength of the system. The skilled artisan will understand that a proper balance of cycloaliphatic diamines (which create a strong, but brittle polymer network) with long chain aliphatic diamines (which yield a weaker, but flexible polymer network) in the curing agent makes a good combination of high compressive and flexural strength in the cured polymer. A small addition of tertiary amine regulates the reaction kinetics. The addition of a diluent, if desired, must be carefully balanced against final strength requirements, as there is a trade-off between diluent and overall strength.

It is preferable to use a small particle size component for the aggregate. The aggregate particle acts as a void and would not provide the tensile/flexural strength, so the particle used was below about 1 mm. As seen in Table 6 below, the product of the present invention provided the highest flexural strength in a 3-gal liquid kit while maintaining high flowability. Flexural strength is significant because the mechanical properties of the grout profoundly affect the overall strength and engineering performance of the final jacketed column. It is the result of carefully designed combination of liquids and the aggregate. Bond strength in epoxies is important, and particularly so in marine environments, to limit the number of different reinforcements required to install a pile restoration.

TABLE 6
Flexural properties with aggregate load optimized to similar flow

| | | | | 1″ |
|---|---|---|---|---|
| | 3-gal kit | Flexural | Flexural | Flow |
| | Aggregate | Strength | Modulus | Box |
| Product | Load (lb) | (psi)^{a} | (psi)^{b} | (sec)^{c} |
| This invention | 150 | 5,590 | 1,860,000 | 6 |
| Denso SeaSheld 550 | 150 | 4,700 | 892,000 | 6 |
| Sika Sikadur 35 HI-MOD LPL | 80 | 4,510 | 1,690,000 | 9 |
| (reduced agg. load) | | | | |
| Sika Sikadur 35 HI-MOD LPL | 100 | 4,680 | 2,000,000 | 21 |
| (max aggregate load) | | | | |

^{a}ASTM C-580
^{b}ASTM C-580
^{c}ASTM C-1339

### Example

Tables 7A-C present additional data representing fifteen batches, in order to better illustrate the variation in formulations and the resulting physical properties.

TABLE 7A
Resin formulations (all figures represent
parts by weight in each batch)

| | Part A^{a} | | | | Part B^{b} | | | |
|---|---|---|---|---|---|---|---|---|
| # | Bis-A | Bis-F | EHGE | BA | IPDA | PL | TA | BA |
| 1 | 305 | 120 | 75 | 26.3 | 99 | 76 | 15 | 42 |
| 2 | 305 | 120 | 75 | 26.3 | 99 | 76 | 15 | 42 |
| 4 | 353.8 | 139.2 | 87 | 0 | 100 | 76 | 34 | 9 |
| 5 | 317.2 | 124.8 | 78 | 0 | 100 | 76 | 34 | 9 |
| 6 | 341.6 | 134.4 | 84 | 0 | 100 | 76 | 34 | 9 |
| 7 | 329.4 | 129.6 | 81 | 0 | 100 | 76 | 34 | 9 |
| 8 | 305 | 120 | 75 | 0 | 100 | 76 | 34 | 9 |
| 9 | 305 | 120 | 75 | 26.3 | 100 | 76 | 25 | 0 |
| 10 | 305 | 120 | 75 | 26.3 | 100 | 76 | 25 | 10 |
| 11 | 305 | 120 | 75 | 26.3 | 100 | 76 | 25 | 20 |
| 12 | 305 | 120 | 75 | 26.3 | 100 | 76 | 25 | 30 |
| 13 | 305 | 120 | 75 | 0 | 99 | 76 | 8 | 68 |
| 14 | 305 | 120 | 75 | 26.3 | 99 | 76 | 15 | 42 |
| 15 | 286.7 | 112.8 | 70.5 | 0 | 99 | 76 | 15 | 68 |
| 16 | 286.7 | 112.8 | 70.5 | 0 | 99 | 76 | 15 | 90 |

^{a}Abbreviations Part A: Bis-A = bisphenol A diglycidyl ether; Bis-F = bisphenol F diglycidyl ether; EHGE = ethyl hexyl glycidyl ether; BA = benzyl alcohol
^{b}Abbreviations Part B: IPDA = isophorone diamine; PL = plasticizer (Jeffamine ® D-2000); TA = tertiary amine (e.g., Ancamine ® K-54 tris-(dimethylaminomethyl) phenol, Evonik Corp.); BA = benzyl alcohol

TABLE 7B
Aggregate loading, total % benzyl alcohol (liquids basis), and ratio
of resin to hardener for the same fifteen batches as in Table 7A

| | |
|---|---|
| Part C^{a} | Mix Details |

| | Aggregate load, | % BA (total in | R/H |
|---|---|---|---|
| # | wt. % | A + B)^{b} | stoichiometry^{c} |
| 1 | 88.4 | 9.01 | 1.05 |
| 2 | 88.4 | 9.01 | 1.05 |
| 4 | 86.9 | 1.13 | 1.21 |
| 5 | 86.9 | 1.22 | 1.08 |
| 6 | 86.9 | 1.16 | 1.17 |
| 7 | 86.9 | 1.19 | 1.12 |
| 8 | 87.0 | 1.25 | 1.04 |
| 9 | 88.3 | 3.62 | 1.04 |
| 10 | 87.7 | 4.92 | 1.04 |
| 11 | 88.3 | 6.20 | 1.04 |
| 12 | 88.4 | 7.43 | 1.04 |
| 13 | 88.4 | 9.05 | 1.05 |
| 14 | 85.1 | 9.01 | 1.05 |
| 15 | 73.6 | 9.34 | 0.987 |
| 16 | 73.7 | 12.00 | 0.987 |

^{a}Aggregate is 45 parts coarse sand (−16 + 40 mesh), 35 parts fly ash, and 20 parts fine sand (−40 + 70 mesh)
^{b}Total % of benzyl alcohol in Parts A + B after mixing
^{c}Based on [(mass of resin)/(epoxy equivalent weight)]/[(mass of hardener)/(active H equivalent weight)]

TABLE 7C
Physical properties of the same fifteen
batches as in Tables 7A and 7B

| | Density | Strength, 1 day | Strength, 7 day |
|---|---|---|---|
| # | (g/cm³) | (psi)^{a} | (psi)^{b} |
| 1 | 1.975 | 5,650 | 14,040 |
| 2 | 2.08 | 8,290 | 14,099 |
| 4 | 2.05 | 7,598 | 17,709 |
| 5 | 2.08 | 7,587 | 17,324 |
| 6 | 2.02 | 7,534 | 17,114 |
| 7 | 2.02 | 7.750 | 17,011 |
| 8 | 2.06 | | 16,700 |
| 9 | 2.11 | 7,821 | 15,840 |
| 10 | 2.11 | 7,952 | 15,020 |
| 11 | 2.15 | 7,585 | 14,140 |
| 12 | 2.13 | 7,200 | 13,280 |
| 13 | 2.02 | 2,650 | 9,770 |
| 14 | 1.88 | | 13,830 |
| 15 | 1.67 | 4,125 | 10,755 |
| 16 | 1.70 | 3,450 | 9,200 |

^{a}ASTM C579B compressive strength at 1 day
^{b}ASTM C579B compressive strength at 7 days

The increased wet and dry bond strength, tensile, and flexural strength of the new epoxy of the present invention increases the overall strength of the repair system. Also, increased tensile strength of the epoxy fill increases the strength and durability of the pile jacket/epoxy fill system. This potentially eliminates the need to use rebars and/or other reinforcements for the repaired piles. One can see from the tables that very high BA content and/or lower aggregate loading can reduce the overall compressive strength somewhat (note in particular batches 13-16); however, the skilled artisan can determine through routine experimentation the optimum mix for a particular application. An application that requires higher fluidity, e.g., might call for more BA provided that a tradeoff in strength can be tolerated.

Further, the use of a product that does not contain toxic nonylphenol or butyl glycidyl ether (BGE) minimizes the risk of contaminating the marine life in the typical pile restoration application.

It is also beneficial to provide the ability to fill very tall repairs requiring vertical filling, for example up to 25 feet in ¾″ annular spaces, from one filling point, with lower (safer) pumping pressures, and a homogeneous composition without the use of toxic nonylphenol or BGE or unstable air entrainment.

Typically, at lower aggregate loads, segregation can be an issue. This a particular issue in vertical filling repairs where the material is vertically pumped into place in long flows at relatively low viscosities. This is typical in a marine environment where entrained air is released during the vertical installation migrating to the top surface causing honeycombing. Segregation of the aggregate and liquids during vertical pumping and placement is also an issue. Segregation also causes non-homogeneous layers of high and low aggregate loading levels across a vertical placement creating inconsistent mechanical properties. The selection of the engineered aggregate, resin, hardener and surfactants can therefore be optimized to improve flow and allow for high aggregate loading levels while maintaining a homogeneous mixture.

In addition, the composite action of the high strength epoxy properties and the strong chemical and mechanical bonds to the fiberglass improve the structural capability of the composite. That combination and synergy of the composite system of fiberglass and the inventive epoxy fill might impact the mechanical properties of the whole repair and the new ways it is being applied.

### Example

Table 8 provides extended testing data of the formula of the present invention at different aggregate loading compared to currently known pile jackets.

TABLE 8
Test data comparing the formula of the present invention to a conventional pile jacket grout

| Property | Req. | Method | A^{a} | B^{b} | C^{b} | D^{b} |
|---|---|---|---|---|---|---|
| Kit A + B | — | — | 4 | 3 | 3 | 3 |
| [gallons] | | | | | | |
| Aggregate load | — | — | 150 | 100 | 150 | 200 |
| [lb] | | | | | | |
| Mix Viscosity A + B | — | ASTM | 420 | 140 | 140 | 140 |
| [cps] | | C2393 | | | | |
| Gel Time @71 F. 250 g | — | E006^{c} | 58 | 45 | 45 | 45 |
| [mins] | | | | | | |
| Yield/kit @10′ | — | n/a | 1.85 | 1.09 | 1.49 | 1.84 |
| [cu. ft.] | | | | | | |
| B: Flow Box Time (1 | — | E003^{c} | 28.0 | 3.0 | 5.8 | 18.1 |
| inch) [sec] | | | | | | |
| Compressive strength 1D | — | ASTM | 2,710 | 4,110 | 8,610 | 5,650 |
| [psi] | | C579B | | | | |
| Compressive strength 3D | | ASTM | — | 9,680 | 9,524 | 11,490 |
| [psi] | | C579B | | | | |
| Compressive strength 7D | 7500 | ASTM | 10,100 | 11,120 | 12,010 | 14,040 |
| [psi] | | C579B | | | | |
| Compressive strength | — | ASTM | — | 13,030 | 13,830 | 14,880 |
| 28D [psi] | | C695 | | | | |
| Flexural Strength 14D | 3000 | ASTM | 2,760 | 5,190 | 5,590 | 5,460 |
| [psi] | | C580 | | | | |
| Tan. Flexural Modulus | — | ASTM | | 1,600 | 1,860 | 2,150 |
| 14D [10³ psi] | | C580 | | | | |
| Tensile Strength 7D [psi] | 1800 | ASTM | 1,540 | 2,660 | 2,720 | 2,800 |
| | | C307 | | | | |
| Tensile Modulus 7D [psi] | | ASTM | — | 32,100 | 35,600 | 39,000 |
| | | C307 | | | | |
| Density | | ASTM | 97 | 117 | 119 | 123 |
| [lb/ft³] | | C906 | | | | |
| Bond to Concrete 7D | 2200 | ASTM | — | 2,960 | 2,580 | 3,340 |
| [psi] | | C882 | | | | |
| Bond to Steel 7D | — | ASTM | — | 3,210 | 6/8 | 3,030 |
| [psi] | | C882 | | | | |
| Hardness | — | ASTM | — | 85 | 86 | 88 |
| [Shore-D] | | 2240 | | | | |
| Postcure Shrinkage | — | ASTM | 0.091 | 0.011 | 0.012 | 0.015 |
| 7 Days [%] | | C531 | | | | |
| Postcure Shrinkage | <0.06 | ASTM | — | 0.012 | 0.017 | 0.025 |
| 14Days [%] | | C531 | | | | |
| Linear Shrinkage 7 Days | — | ASTM | 0.091 | 0.087 | 0.063 | 0.054 |
| [%] | | C531 | | | | |
| Linear Shrinkage 14 Days | <0.06 | ASTM | — | 0.089 | 0.067 | 0.063 |
| [%] | | C531 | | | | |

^{a}Prior art (PJG LPL, Five Star Products, Inc.)
^{b}This invention, three different aggregate loadings
^{c}Applicants' in-house ISO test methods (incorporated herein by reference for background purposes)

One can see from the table that the key performance advantages of the invention are fast flow, high early compressive strengths, high flexural strength, and high tensile strength. All ASTM standard test methods that are mentioned herein will be familiar to those skilled in the art. For background purposes, the contents and specifications of all of these standard test methods are incorporated herein by reference in their entirety.

Adhesion tests were conducted to compare the effects of various surface treatments and also to compare the inventive material with several existing products to determine the effect of varying product viscosities, as described in the following examples.

### Example

Adhesion testing was performed on various surface finishes of standard pile jackets in various curing conditions. The surface was treated by sand blasting, peel-ply (leaving a fabric-like surface finish), as-produced (very close to smooth, but with slight layer of various surfaces types), and glass bead coated (the “wet” or uncured surface was covered with glass beads). Testing was done in accordance with ASTM D4541.
Three testing application/cure types were performed:
1) dry application in the lab and then 7 day room temp (71° F.) cure (7D RT);
2) dry application in the lab and then 1 day @ RT and then postcuring @140 F for 16 hr and cooled to RT; and,
3) underwater application in the lab and then 7 day underwater cure @RT (7D underwater).

### Example

Table 9 summarizes the results of adhesion testing for three conditions: sand blasted, peel ply, and as-produced. Some observations can be drawn from the data: On the smooth (as produced) surface, the Mfr. B product showed the best adhesion. This can be interpreted as representing mainly chemical bonding. However, with increased roughness of the surface, (peel-ply and sand blasted), the Mfr. B product was losing adhesion. This is likely because the higher viscosity (surface tension) of Material B was not allowing optimal wetting of the surface, thereby reducing the effective area of the surface over which chemical bonding could occur. The reduced surface contact thereby reduced adhesion (317 psi, then 225, and 226). The highest viscosity (390 cps) did not benefit Material B when surface modifications were applied. The inventive composition exhibited the lowest viscosity of all and performed the best with applied surface modifications. Low viscosity allowed for increased surface contact (chemical bond) and better surface penetration (mechanical bond). Both peel-ply and sand blasted surfaces benefited from the increased wetting and showed the best adhesion. Interestingly, the Mfr. A material was not affected by the differences between surfaces. The skilled artisan will appreciate that the damaged pile being repaired will rarely have a smooth surface. As the lower viscosity of the inventive composition allows it to better penetrate and adhere to a rougher pile jacket surface, so too it will be expected to better penetrate and adhere to the surface of the pile than would conventional higher-viscosity formulas.

TABLE 9
Adhesion test results comparing the Invention to two
competitive products for various surface treatments.

| | This invention | Mfr. A | Mfr. B |
|---|---|---|---|
| | Liquids viscosity (A + B), cps | | |
| | 140 | 155 | 390 |
| | Jacket Surface Treatment | | |
| | Adhesion, | Adhesion, | Adhesion, |
| | psi | psi | psi |
| Sand Blasted | | | |
| 7D RT | 525 | 275 | 275 |
| Post Cure | 463 | 225 | 190 |
| 7D Underwater | 213 | 113 | 213 |
| Peel-Ply | | | |
| 7D RT | 463 | 338 | 238 |
| Post Cure | 438 | 350 | 288 |
| 7D Underwater | 163 | 50 | 150 |
| Smooth | | | |
| 7D RT | 263 | 338 | 288 |
| Post Cure | 300 | 313 | 338 |
| 7D Underwater | 117 | 100 | 325 |

It will be appreciated that the inventive compositions may be provided in the form of a kit containing premeasured containers of Part A, Part B, and aggregate (Part C), so that during the field installation process, the workers do not need to measure the different components, as described in the following example.

### Example

A kit for making pile repairs contains the following: a sealed, 2-gallon plastic bucket containing about 15 lbs. of Part A; a sealed, 1-gallon plastic bottle containing about 6.6 lbs. of Part B; and 150 pounds of aggregate (Part C) in three 50-lb. packages. The aggregate is preferably a blended mixture of sand and fly ash or other fine particles. One kit, in this case, contains three 50-lb. bags of aggregate instead of one 150-lb. bag simply for ease of handling by the user. Either option is considered within the scope of the invention. Any suitable package may be used, including paper sacks, plastic sacks, buckets, pails, etc.
During manufacture, the benzyl alcohol may be apportioned to either or both of Parts A and B in such a way that the total BA content ranges from about 1 to 12 wt. % (liquids basis) and the ratio of Part A to Part B is maintained at approximately 2:1. For this reason, the actual weight of Part A and Part B may vary from the figures given above, but in any case they can be accommodated in the aforementioned 1- and 2-gal. containers. Note also that Part B has lower density than Part A, so 2 gal. Part A typically will weigh more than twice the weight of 1 gal. Part B, as in this example.
The quantities of all three components are premeasured so that in the field, a user simply mixes the entire contents of Parts A, B, and C to achieve a correct, reproducible batch composition with appropriate consistency for pumping and placement into the pile jacket. A further benefit is that each kit produces a well-defined volume of grout, making it easy to estimate the quantities needed for a particular job and to avoid mixing more grout than can be immediately used.

Although Applicants do not require any particular distribution of the benzyl alcohol between Parts A and B, provided the total BA content is sufficiently high to achieve good flow characteristics, in many cases Applicants prefer for Part A (resin) to contain at least some fraction of the total BA. Traditionally, BA is added as a component of Part B (hardener). Usually the main reason to put it in Part B (instead of Part A) is to reach the desired volumetric ratio of A to B. Benzyl alcohol will not react with either Part A or B components. However, dissolution in Part B creates an excessive exotherm (i.e., enthalpy of mixing) and this can be harmful to the amine blend. Many amine hardeners are not recommended to be heated above temperatures as low as 110° F., which could be easily reached and exceeded during addition of benzyl alcohol to the amine blend (hardener). For this reason Applicants prefer to place some portion, or all, of the benzyl alcohol, if possible, on the epoxy resin site. Usually there is more resin volume than hardener can offer and the dissolution would not be as exothermic. Also, no epoxy blend would have the temperature limit as the amine part has. The temperature of epoxy blend can safely go beyond 110° F. during addition with no harm done to the components. Lastly, any heat generated on mixing will be helpful for speeding the cure.

It will be appreciated that the kit described in the preceding example makes it easier to move the BA from Part B to Part A, because the user is not instructed to measure the components, i.e., “Mix two gal of Part A with one gal of Part B,” and instead simply mixes the entire contents of Bucket A and Bucket B, so the actual volumes of the two parts no longer need to be a simple ratio. This has clear benefits to the customer in terms of saving time and preventing errors on the job site.

Environmental Impact

As noted earlier, one important object of the invention is eliminating the release of toxic surfactants into the environment. It is well known that nonylphenol is toxic to marine life; however, to Applicants' knowledge there have been no definitive studies on the specific question of whether or how much nonylphenol might be released to the water during installation or long-term use of pile jacket grouts that contain this substance. Applicants therefore developed a test protocol for this purpose, and the results are described in the following example.

### Example

Applicants developed a leaching test as follows: the freshly mixed grout material was placed/poured into plastic cube molds underwater in a container with known top surface area and with known amount of water. This was left to cure for 24 hours. Then the water was submitted to a commercial testing laboratory (Alliance Technologies, Monmouth Jct., N.J.) for analysis according to ASTM D7065 for nonylphenol (NP), nonylphenol monoethoxylate (NP1EO) and nonylphenol diethoxylate (NP2EO) detection.
Epoxy resins were mixed according to manufacturer's directions. One commercial product contained 1.3% nonylphenol in the mixed product (A+B+C). The inventive product contained no nonylphenol.
Test results, Table 10, showed that nonylphenol was released into the water by the nonylphenol-containing materials and, as expected, none was detected in the water when the inventive nonylphenol-free material was tested. The NP concentration, 194 ppb in the “as-received” water sample, was the result of 1 in² of surface area of the epoxy contacting 200 mL of water, implying a release of 38.8 μg NP/in².

TABLE 10
Estimated concentrations of nonylphenol
and derivatives in water samples

| Analyte | Commercial Product | This invention |
|---|---|---|
| NP | 194.4 μg/L | n.d. |
| NP1EO | n.d. | n.d. |
| NP2EO | n.d. | n.d |

It will be appreciated that all of the inventive formulations are preferred to be substantially free of nonylphenol. By “substantially free” Applicants mean that nonylphenol is not intentionally added to the mix and is not needed in the mix to achieve acceptable flow characteristics. However, the presence of unavoidable trace levels of nonylphenol, e.g., as byproduct impurities arising during the production of particular components in the mix, cannot necessarily be ruled out. In any case, it can be seen that nonylphenol is released into water by conventional materials at easily-detected levels, whereas in the inventive material, no release was observed.

We claim:

1. A two-part polymer composition for marine repairs comprising:
a liquid epoxy blend comprising up to 15 wt. % benzyl alcohol and having a viscosity of 200 to 1100 cps; and,
a liquid hardener comprising up to 25 wt. % benzyl alcohol and having a viscosity of 30 to 85 cps;
wherein the total benzyl alcohol content when said epoxy and said hardener are combined ranges from 1 to 12 wt. %.

2. The composition of claim 1 wherein said liquid epoxy blend comprises at least one component selected from the group consisting of: bisphenol A, bisphenol F, bisphenol E, aliphatic mono- and di-glycidyl ethers thereof, and ethyl hexyl diglycidyl ether.

3. The composition of claim 1 wherein said liquid hardener comprises at least one compound selected from the group consisting of: cyclohexanemethanamine, 5-amino-1,3,3-trimethyl-, any cycloaliphatic mono-, di-, and tri-amine, isophoronediamine (IPDA), aliphatic amines, and aromatic amines.

4. The composition of claim 1 wherein said liquid hardener comprises a flexibilizing agent.

5. The composition of claim 4 wherein said flexibilizing agent comprises polyoxypropylenediamine of a selected molecular weight.

6. The composition of claim 1 wherein said liquid hardener comprises up to 15 wt. % of at least one catalyst.

7. The composition of claim 6 wherein said catalyst comprises at least one compound selected from the group consisting of: 2,4,6-tris(dimethylaminomethyl)phenol and bis(dimethylaminomethyl)phenol.

8. The composition of claim 1 further comprising an inorganic filler material.

9. The composition of claim 8 wherein said inorganic filler material comprises 10 to 50 wt. % of particles under 150 μm and 50 to 90 wt. % of particles between 150 μm and 1.18 mm.

10. The composition of claim 9 wherein said particles under 150 μm comprise fly ash and said particles in the range of 150 μm to 1.18 mm comprise sand.

11. A polymer composite composition for marine repairs comprising:
a liquid epoxy blend comprising up to 15 wt. % benzyl alcohol and having a viscosity of 220 to 1100 cps;
a liquid hardener comprising up to 25 wt. % benzyl alcohol and having a viscosity of 30 to 85 cps; and wherein the total benzyl alcohol content of the combined resin and hardener ranges from 1 to 12 wt. %; and,
a particulate inorganic filler comprising 10 to 50 wt. % of particles under 150 μm and 50 to 90 wt. % of particles between 150 μm and 1.18 mm.

12. The composite composition of claim 11 wherein said liquid epoxy blend comprises at least one component selected from the group consisting of: bisphenol A, bisphenol F, bisphenol E, aliphatic mono- and di-glycidyl ethers thereof, and ethyl hexyl diglycidyl ether.

13. The composite composition of claim 11 wherein said liquid hardener comprises at least one compound selected from the group consisting of: cyclohexanemethanamine, 5-amino-1,3,3-trimethyl-, any cycloaliphatic mono-, di-, and tri-amine, isophoronediamine (IPDA), aliphatic amines, and aromatic amines.

14. The composite composition of claim 13 wherein said liquid hardener comprises a flexibilizing agent.

15. The composite composition of claim 14 wherein said flexibilizing agent comprises polyoxypropylenediamine of a selected molecular weight

16. The composite composition of claim 11 wherein said liquid hardener comprises up to 15 wt. % of at least one catalyst.

17. The composite composition of claim 16 wherein said catalyst comprises at least one compound selected from the group consisting of: 2,4,6-tris(dimethylaminomethyl)phenol and bis(dimethylaminomethyl)phenol.

18. A grout preparation kit for marine repairs comprising:
a first package holding a first premeasured quantity of a liquid epoxy blend comprising up to 15% benzyl alcohol and having a viscosity of 200 to 1100 cps;
a second package holding a second premeasured quantity of a liquid hardener comprising up to 25% benzyl alcohol and having a viscosity of 30 to 85 cps; and,
a third package holding a third premeasured quantity of a dry particulate filler comprising 10 to 50 wt. % of particles under 150 μm and 50 to 90 wt. % of particles between 150 μm and 1.18 mm, wherein:
the premeasured quantities of the liquid epoxy blend and hardener, when combined, comprise 1 to 12 wt. % benzyl alcohol, and,
the premeasured quantity of dry particulate filler, when combined with the premeasured quantities of epoxy blend and hardener, produces a flowable grout composition suitable for placement into a pile jacket.

19. A method for protecting a marine structure comprising the steps of:
forming a split polymer composite jacket;
placing the composite jacket around a selected marine structure;
drawing the composite jacket together and securing the resulting overlap;
sealing the bottom of the jacket with a curable composition;
forming an epoxy grout composition comprising:
a liquid epoxy resin comprising up to 15 wt. % benzyl alcohol and having a viscosity of 220 to 1100 cps;
a liquid hardener comprising up to 25 wt. % benzyl alcohol and having a viscosity of 30 to 85 cps, and, wherein the total benzyl alcohol content of the combined resin and hardener ranges from 1 to 12 wt. %; and,
a particulate filler comprising 10 to 50 wt. % of particles under 150 μm and 50 to 90 wt. % of particles between 150 μm and 1.18 mm;
blending the epoxy grout composition and placing it into the annular space between the polymer composite jacket and the marine structure; and,
allowing the epoxy grout composition to cure in place.

20. The method of claim 19 further comprising the step of:
applying a splash zone compound to the top of the repair to seal against water ingress.
